(19) United States
(12) Patent Application Publication
(10) Pub. No.: US 2005/0235313 A1
(43) Pub. Date: Oct. 20, 2005

(54) Program information acquisition apparatus, program information acquisition method, and program information acquisition program

(76) Inventors: Akihito Yamada, Tokyo (JP); Masayoshi Murayama, Tokyo (JP); Hiroshi Kida, Tokyo (JP); Nozomu Kikuchi, Tokyo (JP); Hideyuki Uchiyama, Tokyo (JP); Takanori Harada, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/092,990

(22) Filed: Mar. 30, 2005

(30) Foreign Application Priority Data
Mar. 31, 2004 (JP) 2004-102588

(51) Int. Cl. H04N 5/50

(52) U.S. Cl. 725/38

(57) ABSTRACT

A program information acquisition apparatus includes a program information acquisition unit, a program information accumulation unit, and a program information acquisition determining unit. In this configuration, a start of an acquisition operation by the program information acquisition unit is determined based on an information accumulation status of the program information accumulation unit. Thus, program information distributed from a desired reception target can be accumulated as the latest information as much as possible. Since unneeded program information is not acquired, program information acquisition with high energy saving effects is made possible.

### BACKGROUND OF THE INVENTION

The present invention relates to a program information acquisition apparatus, a program information acquisition method, and a program information acquisition program.

The present application claims priority from Japanese Patent Application No. 2004-102588, the disclosure of which is incorporated herein by reference.

With the development of broadcasting techniques in recent years, various information (the contents or programs) are broadcasted in various systems such as a terrestrial broadcasting (analog or digital) system, a BS (Broadcasting Satellite; analog or digital) system, and a CS (Communication Satellite; analog or digital) system. In order to respond to such diversification of the broadcasting systems and multiplication of the number of channels, a service for distributing electronic program information (EPG (Electrical Program Guide) information) solely or after multiplexing the EPG information with a broadcast signal is provided.

The program information is, for example, distributed in the following manner in the case of the BS digital broadcasting. Program information of all channels providing programs in the BS digital broadcasting are assembled to be distributed to all the channels. Therefore, a receiver who is receiving a program broadcasted on any channel can acquire program information for all the channels. In the case of the CS digital broadcasting, a platform provider collectively manages the program information, and a certain repeater transmits all the program information. As a result, a receiver who receives the information through the repeater can acquire all the program information in the CS digital broadcasting.

On the other hand, in the terrestrial digital broadcasting, a distribution system, in which each channel individually multiplexes its own program information with a broadcast signal for distribution, is used. Since a receiver can acquire only the program information of a selected channel, it is necessary for the receiver to select all the channels in the terrestrial digital broadcasting so as to receive and acquire the program information of all the channels.

The program information distributed from such various distributors not only substitute for a program listing in newspapers or magazines but also advantageously serve as control information that can be used for scheduled viewing or programmed recording of a broadcast program. In order to utilize the program information for such purposes, a receiving apparatus is required to have a function of acquiring the program information. Japanese Patent Application Laid-Open No. 2004-88282 discloses the following digital broadcast receiving apparatus. The digital broadcast receiving apparatus includes: program information acquisition means for acquiring program information; program information storage means for storing the program information acquired by the program information acquisition means; program listing creation means for creating a program listing based on the program information stored in the program information storage means; and program listing display means for displaying the program listing created by the program listing creation means in response to a display instruction of the program listing.

Many program information acquisition apparatuses having the function of acquiring the program information for use (including that built in a broadcast receiving apparatus, a broadcast receiving apparatus itself, that built in a display apparatus or a video recording apparatus, a computer provided with a program information acquisition function by a software and the like) include program information accumulation means for storing and accumulating acquired program information (in the above-described example, the program information storage means) as described in the above-cited patent publication. The program information acquisition apparatus including such program information accumulation means is advantageous in its capability of immediately displaying a program listing because it is not necessary to acquire program information from a distributor (a target from which a broadcast is received when viewed from the receiver side) for each use of program information. However, the accumulated program information may not necessarily be the latest one. Moreover, it is apparent that desired program information cannot be used unless the program information is acquired from a distributor.

Taking the above-described case of the acquisition of program information in the terrestrial digital broadcasting as an example, since the user can acquire program information with a broadcast signal at the selection of a channel on which the user watches a program, it is possible to construct a system of comparing the acquired program information with already accumulated program information so as to accumulate an updated part as needed as well as to delete old information at each selection of a channel. According to such a system, the latest program information is always accumulated for a channel on which the user frequently watches programs. On the other hand, for a channel on which the user rarely watches programs, however, there may arise a situation that program information is not accumulated or updated. Therefore, for scheduled viewing of a program to be broadcasted a few days later on a channel on which the user has not watched programs for a while, it is necessary to select a desired channel so as to acquire program information in the operation for scheduled viewing. Therefore, it is inconvenient that waiting time for the acquisition of program information is needed.

Moreover, such a problem is not limited to the above-described acquisition of program information in the terrestrial digital broadcasting. For example, a receiving apparatus common to various broadcast systems (BS, CS, terrestrial broadcasting and the like) or an information acquisition apparatus for aggregating broadcast signals from these broadcast systems is conceived so as to construct a program information acquisition apparatus having the program information accumulation means described above in conformity with the receiving apparatus or the information acquisition apparatus. In such a case, if a user who frequently watches only BS programs wants to use information of a program distributed a few days later on a channel in the CS, for example, the latest program information is accumulated for the BS whereas some program information is not accumulated for the CS. Therefore, there arises the same problem as that in the program information acquisition in the terrestrial digital broadcasting described above. Moreover, even a receiving apparatus exclusively for the BS cannot acquire program information unless the receiving apparatus is brought into a receivable status. Therefore, if the latest program information is desired to be used after the apparatus is not used for a while, it is necessary to first acquire the latest program information. Therefore, the user needs waiting time for the acquisition of program information.

In order to solve the problem, the following method is conceived. The apparatus is regularly driven by a timer in a time zone in which the user does not watch programs (for example, late at night) so as to select a channel from all the target channels as needed. When the acquisition of updated program information from one channel is completed, a next channel is automatically selected to acquire the program information. This operation is performed for all the target channels so that the updated program information is always accumulated as the latest program information for all the target channels (in practice, many terrestrial digital broadcast receiving apparatuses use such a system).

According to the method of regularly selecting all the target channels to acquire program information, however, time required for the acquisition is quite long if the number of target channels is large. Correspondingly, energy consumption is increased. Moreover, since all the information is not necessarily effectively used, the above-described system is not effective as a program acquisition function in view of energy saving. Furthermore, if the acquisition of program information is always performed on a regular basis, the time zone required for the program information acquisition always hinders the user's view. Thus, the user sometimes cannot watch a program that he or she wants to watch. On the other hand, if priority is given to the user's viewing, program information cannot be effectively acquired.

### SUMMARY OF THE INVENTION

The present invention has an object of coping with such problems as an example. Specifically, the present invention has an object of enabling accumulation of program information distributed from a desired reception target as the latest information as much as possible, enabling acquisition of program information with high energy saving effects without acquiring unnecessary program information, effectively acquiring program information with high utility for a user and the like in a program information acquisition apparatus (method or program) including at least program information acquisition means for acquiring distributed program information and program information accumulation means for accumulating program information acquired by the program information acquisition means.

In order to achieve the above object, the program information acquisition apparatus, the program information acquisition method and the program information acquisition program according to the present invention have at least the configuration according to each of the following aspects.

According to a first aspect of the present invention, a program information acquisition apparatus comprises: a program information acquisition unit for acquiring program information distributed from a reception target; a program information accumulation unit for accumulating the program information acquired by the program information acquisition unit; and a program information acquisition determination unit for determining a start of the acquisition operation by the program information acquisition unit based on an information accumulation status of the program information accumulation unit.

According to a second aspect of the present invention, a program information acquisition method comprises the steps of: acquiring program information distributed from a reception target by a program information acquisition unit; accumulating the acquired program information in a program information accumulation unit; and determining a start of the acquisition operation by the program information acquisition unit based on an information accumulation status of the program information accumulation unit.

According to a third aspect of the present invention, a computer-readable medium containing a program information acquisition program allows a computer to be functioned as: a program information acquisition unit for acquiring program information distributed from a reception target; a program information accumulation unit for accumulating the program information acquired by the program information acquisition unit; and a program information acquisition determining unit for determining a start of the acquisition operation by the program information acquisition unit based on an information accumulation status of the program information accumulation unit.

### BRIEF DESCRIPTION OF THE DRAWINGS

These and other objects and advantages of the present invention will become clear from the following description with reference to the accompanying drawings, wherein:

FIG. 1 is an explanatory view showing the basic configuration of a program information acquisition apparatus according to an embodiment of the present invention;

FIG. 2 is an explanatory view showing a flow of basic functions of the program information acquisition apparatus or a program information acquisition method according to the embodiment of the present invention; and

FIGS. 3A and 3B are explanatory views for illustrating functions of a program information acquisition determining unit in the program information acquisition apparatus according to the present invention.

### DETAILED DESCRIPTION OF THE PREFERRED EMBODIMENT

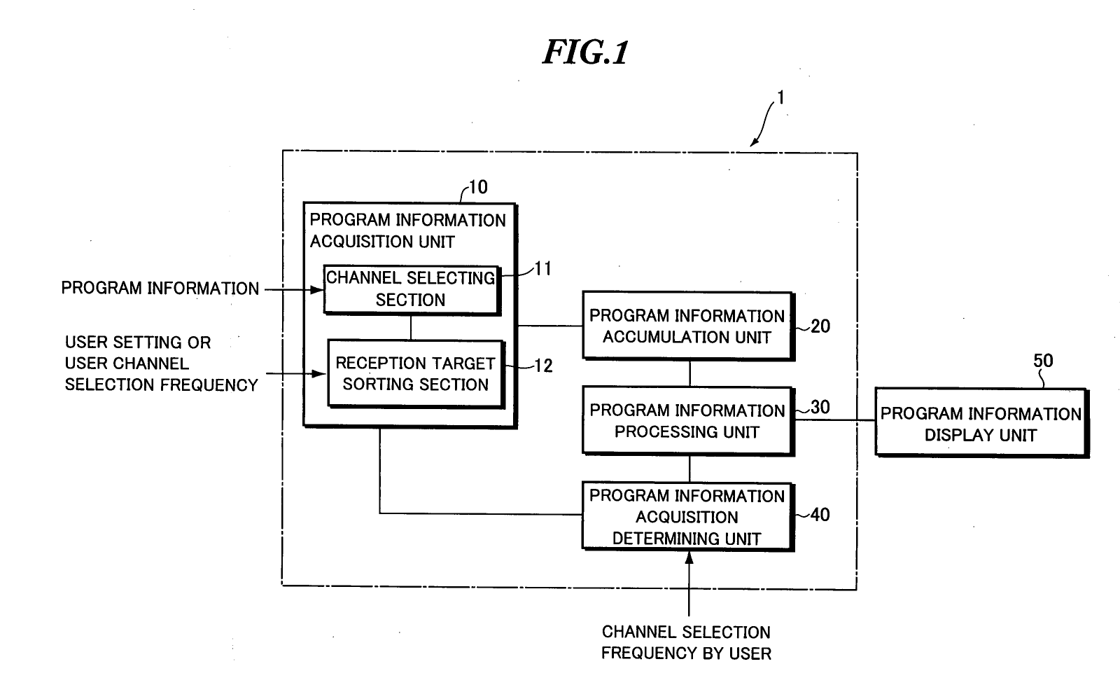

Hereinafter, an embodiment of the present invention will be described with reference to the accompanying drawings. FIG. 1 is an explanatory view showing the basic configuration of a program information acquisition apparatus according to one embodiment of the present invention. According to this configuration, it is premised that a program information acquisition apparatus 1 includes at least: a program information acquisition unit 10; and a program information accumulation unit 20. On the other hand, as a characteristic configuration, the program information acquisition apparatus 1 includes a program information acquisition determining unit 40. Furthermore, the program information acquisition apparatus 1 also includes a program information processing unit 30 for processing program information accumulated in the program information accumulation unit 20 so as to transmit a signal to a program information display unit 50 or the above-described program information acquisition determining unit 40.

Herein, the program information acquisition unit 10 has a function of acquiring program information distributed from a target from which a broadcast is received (a distributor or the like; hereinafter, simply referred to as a reception target). More particularly, the program information acquisition unit 10 includes a channel selecting section 11 for selecting a channel as a reception target; and a reception target sorting section 12 for sorting a reception target from which program information is acquired. The program information accumulation unit 20 has a function of accumulating the program information acquired by the program information acquisition unit 10.

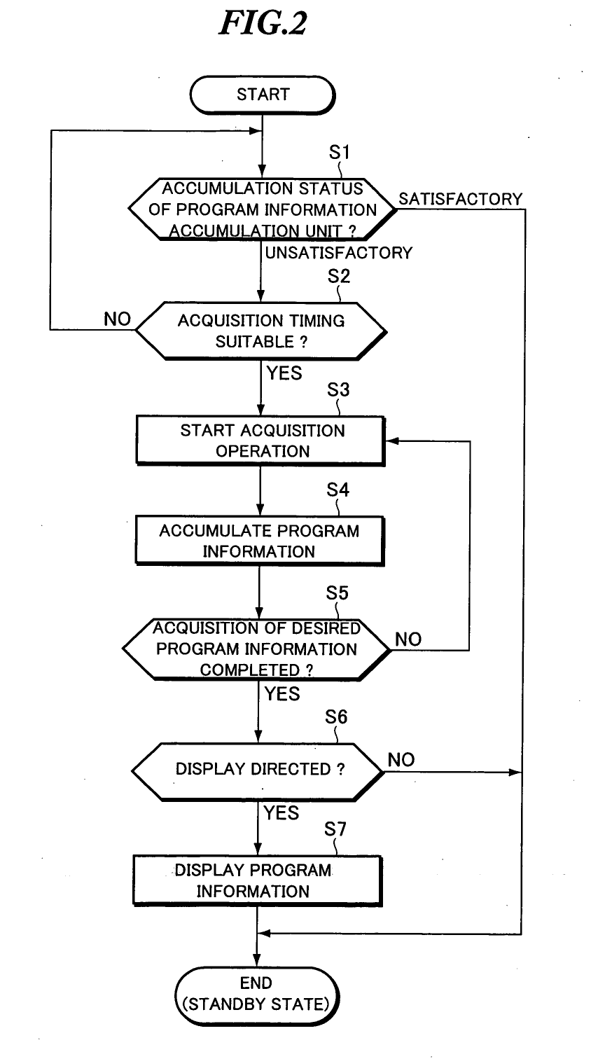

FIG. 2 is an explanatory view illustrating a functional flow of the program information acquisition apparatus 1 as described above or a program information acquisition method. The principal function of the program information acquisition apparatus 1 according to the embodiment of the present invention is that an information accumulation status of the program information accumulation unit 20 is confirmed so as to determine the start of an acquisition operation by the program information acquisition unit 10 based on the information accumulation status. Herein, the determination of the start of the acquisition operation does not necessarily mean that the acquisition operation is immediately started by an output of determination by the program information acquisition determining unit 40.

The description will be given along a flow in FIG. 2. After the program acquisition function is started (the program acquisition function is always ready to be started while the apparatus is being in a standby state in some cases and is started by a predetermined trigger in the other cases), the information accumulation status of the program information accumulation unit 20 is determined by the program information acquisition determining unit 40 (S1). For example, if it is determined that a satisfactory accumulation status has been established, the apparatus is continuously put in a standby state. On the other hand, if it is determined that the accumulation status is unsatisfactory, the result of determination is output.

When the acquisition of program information is immediately started by the output of determination, the user's viewing is hindered, for example, if the user is watching a program. Therefore, the program information acquisition unit 10 determines whether the acquisition timing is suitable or not (S2). If the acquisition timing is not suitable, the apparatus returns to a standby state. When suitable timing comes, the acquisition operation of program information starts (S3).

After the program information is acquired, the acquired program information is accumulated each time in the program information accumulation unit 20 (S4). Then, the program information acquisition unit 10 determines whether the acquisition of desired program information has been completed or not (S5). The acquisition operation is continued until the acquisition is completed. If it is determined that the acquisition is completed, for example, it is determined whether display is directed by the program information processing unit 30 or not (S6). If the display is not directed, the apparatus returns to a standby state. On the other hand, if the display is directed, the program information is displayed (a program listing is displayed) by the function of the program information display unit 50 (S7).

According to the program information acquisition apparatus 1 or the program information acquisition method as described above, the information acquisition is determined based on the information accumulation status of the program information accumulation unit 20 as compared with the conventional apparatus or method of regularly acquiring program information for update. Therefore, unnecessary acquisition of the program information is not performed so that unneeded power consumption can be advantageously avoided. Moreover, program information can be acquired so as to fill a vacant area before the vacant area becomes large in the information accumulation status. Therefore, even in the case where, for example, the user wants to confirm a program to be broadcasted a few days later on a channel on which the user has not watched programs for a while, information of the program that the user wants to watch can be obtained from the accumulated program information. Furthermore, since it is not necessary to acquire the program information within a predefined time zone, it is possible to set the acquisition of program information avoiding the time zone in which the user watches programs as much as possible. Accordingly, effective acquisition of program information giving priority to the user's viewing is made possible.

Hereinafter, a further specific embodiment of the present invention will be described. Although the case where program information is distributed on each channel as in terrestrial digital broadcasting is described herein, the present invention is not particularly limited thereto as described below.

First, a function of the program information acquisition determining unit 40 is described. As an example, the program information acquisition determining unit 40 outputs the determination based on a program information non-accumulation area obtained by subtracting a program information accumulation area where program information is already accumulated from a maximum program information accumulation area which can accumulate program information in the program information accumulation unit 20. Herein, the maximum program information accumulation area is an accumulation area in the program information accumulation unit 20, which is required for accumulating: (the number of all channels corresponding to reception targets)×(a continuous time duration of a program accumulated in one program information acquisition). The program information non-accumulation area is a vacant area obtained by subtracting the accumulation area, in which program information is already accumulated, from the maximum program information accumulation area described above.

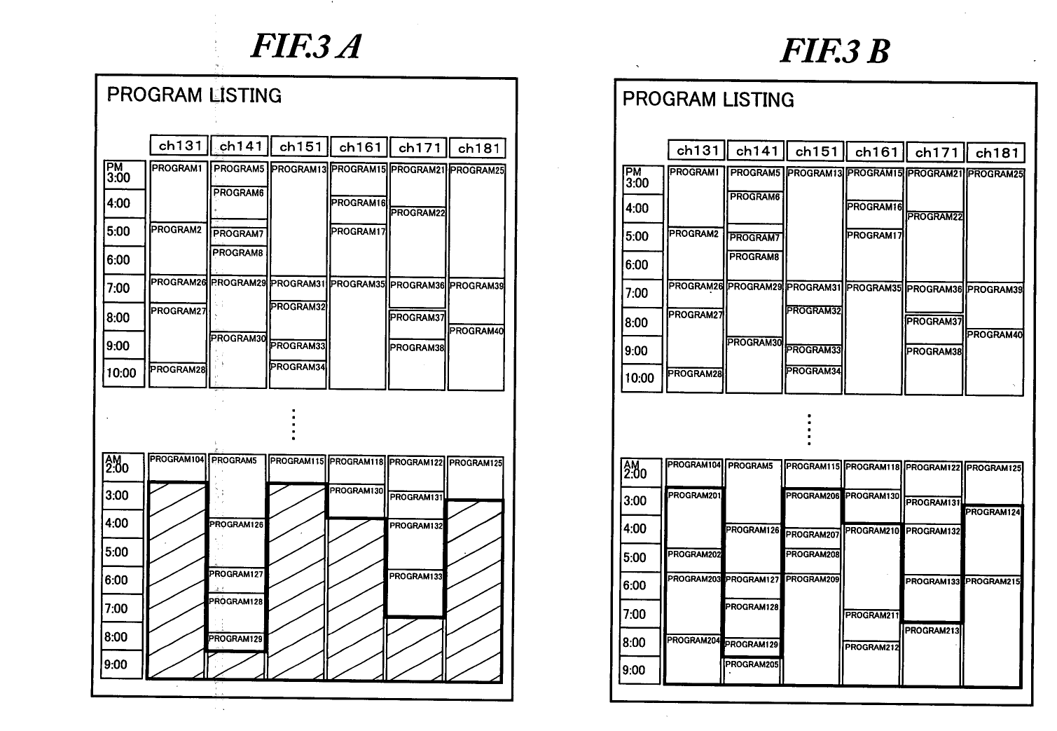

The function of the program information acquisition determining unit 40 will be described with reference to FIGS. 3A and 3B. FIG. 3A shows a program listing based on an information accumulation status immediately before the program information acquisition determining unit 40 outputs the determination of the start of an acquisition operation. In the program information accumulation unit 20, if all channels are selected at a certain point of time so as to bring about an information accumulation status where the above-described maximum program information accumulation area is entirely filled with program information, information of a program whose broadcast is terminated is deleted as needed with elapse of time. Therefore, if no program information is acquired during such a time period, a program information non-accumulation area (a vacant area) is gradually increased as a hatched area in FIG. 3A. However, for a channel selected by the user in such an operation, program information is acquired at the selection of the channel. Therefore, a vacant area is partially filled only for the selected channel. In the example shown in FIG. 3A, for a channel 141 and a channel 171, program information is acquired by the selection of the channels by the user so as to fill a large part of the vacant area.

Then, based on the determination criterion that the vacant area is increased to be in a set state, the determination is output from the program information acquisition determining unit 40. This determination output will be described in accordance with the functions of the respective units. The program information processing unit 30 obtains data for an existing information accumulation status from the program information accumulation unit 20 so as to perform computing processing based on the obtained data, thereby obtaining a program information non-accumulation area. Then, data for the obtained program information non-accumulation area is transmitted to the program information acquisition determining unit 40 so as to be compared with a determination criterion.

FIG. 3B shows a program listing based on an accumulation status of the program information accumulation unit 20 immediately after the completion of the program information acquisition operation. Herein, all channels are selected so that the above-described vacant area is fully filled with new program information.

The above-described program information non-accumulation area is obtained for each reception target (channel). For example, a program information non-accumulation area for a reception target to which the user does not subscribe can be excluded from determination. Since the vacant area necessarily increases in the case where there is a channel to which the user does not subscribe, program information acquisition can be more effectively determined by excluding such a channel from determination.

Alternatively, instead of simply comparing the size of the vacant area with the determination criterion, the program information non-accumulation area obtained for each reception target (channel) may be weighted based on the frequency of channel selection by the user so as to output the determination based on the weighted vacant area. The frequency of channel selection by the user can be acquired by providing means for storing a channel selection status of the user for a reception device or the like.

Specifically, it is considered that the need for program information is low for a channel rarely selected by the user. Therefore, the determination is not output for such a channel even if the vacant area becomes somewhat large. If a vacant area is generated for the channel that has not recently been selected by the user despite a relatively high frequency of selection by the user, the determination is output even if the vacant area is small. According to such an output of determination, more effective program information acquisition in accordance with the status of use by the user is made possible.

As timing of the determination processing by the program information acquisition determining unit 40, the determination processing may be performed constantly or at a constant frequency while the apparatus is being in a standby state, or may be performed by a predetermined trigger as described above. For example, at the start of a standby state with an auxiliary power source when the apparatus is turned OFF, the program information processing unit 30 is actuated so as to extract data for the program information non-accumulation area. According to this method, since the power-OFF period of the apparatus normally corresponds to a time period in which the user does not use the apparatus, the processing is performed so as not to hinder the use by the user. Alternatively, in combination with the conventional technique, the apparatus may be actuated by a timer. Thereafter, when the apparatus is turned OFF, the program information processing unit 30 may be actuated so as to extract data for the program information non-accumulation area.

Next, specific functions of the program information acquisition unit 10 will be described. As a specific example of the program information acquisition unit 10, the program information acquisition unit 10 includes the channel selecting section 11 and the reception target sorting section 12 as described above. In addition, various modes can be conceived for the acquisition operation in response to the determination by the program information acquisition determining unit 40.

Specifically, as an example, as shown in FIGS. 3A and 3B, program information is acquired in such a manner that the above-described vacant area is fully filled with program information by selecting all reception targets (channels) in response to the output from the program information acquisition determining unit 40. According to this operation, even in the case where the user is going to accidentally schedule the viewing of a program to be broadcasted a few days later on a channel that the user does not normally watch programs or the like, desired information can be obtained for use from the accumulated program information. Therefore, an operation of scheduling the viewing of a program or the like can be promptly performed.

Moreover, as an example, the function of the reception target sorting section 12 is used. The reception target sorting section 12 is for sorting out a reception target from which program information is acquired. Only a sorted reception target (channel) is selected so as to acquire the program information therefrom. According to this method, since unnecessary program information is not acquired, program information acquisition time can be reduced. As a result, energy saving effects can be further enhanced. Moreover, the possibility of hindering the user's viewing during program information acquisition is further reduced.

Specifically, the reception target sorting section 12 is allowed to sort out a reception target (channel), from which program information is acquired, based on the user setting. As a result, only the program information on a channel desired by the user can be acquired.

Moreover, the reception target sorting section 12 is allowed to sort out a reception target (channel), from which program information is acquired, based on the frequency of channel selection by the user. The frequency of channel selection by the user can be acquired by providing the means for storing a channel selection status by the user for a reception apparatus or the like as described above. According to this method, more effective program acquisition in consideration of the status of use by the user is made possible.

By the program information acquisition apparatus, method, and program according to the above-described embodiment, program information distributed from a desired reception target can be accumulated as the latest information as much as possible. As a result, the user can use the accumulated program information without any waiting time. Moreover, information program acquisition with high energy saving effects is possible without acquiring unneeded program information. Furthermore, program information is acquired effectively in conformity with the usage pattern of the user.

The program information acquisition apparatus 1 having the functions of the respective units described above may be in any form, for example, may be built in a broadcast reception apparatus, may be a broadcast reception apparatus itself, may be built in a display apparatus or a video recording apparatus, may be a computer provided with a program information acquisition function by a software, and the like. Therefore, each of the above-described units may be constituted by a program for making a computer function as each of the above-described units.

Furthermore, in the program information acquisition apparatus 1 according to the embodiment of the present invention, the reception target is not limited to terrestrial digital broadcasting. The other broadcasting systems (BS, CS, terrestrial analog broadcasting, and the like) may also be reception targets. The program information acquisition apparatus 1 may also be constructed so as to be common to these broadcasting systems. Furthermore, the program information acquisition patterns include reception through an antenna, reception through a line such as a cable TV circuit or the Internet connection, and the like.

The case where the program information is acquired based on the accumulation status of the program information accumulation unit 20 for each channel has been described in the above-described specific example. However, the program information acquisition is not limited thereto. The embodiment of the present invention can be applied to an apparatus capable of acquiring program information for each type (category, genre, or the like) of programs, which accumulates program information for each type of programs. In such an apparatus, the program information acquisition according to the present invention can be used in the case where program information is accumulated only for a specific type of program whereas a vacant area is generated for the other types of programs, and the like.

While there has been described what are at present considered to be preferred embodiments of the present invention, it will be understood that various modifications may be made thereto, and it is intended that the appended claims cover all such modifications as fall within the true spirit and scope of the invention.

1. A program information acquisition apparatus comprising:
a program information acquisition unit for acquiring program information distributed from a reception target;
a program information accumulation unit for accumulating the program information acquired by the program information acquisition unit; and
a program information acquisition determination unit for determining a start of the acquisition operation by the program information acquisition unit based on an information accumulation status of the program information accumulation unit.

2. The program information acquisition apparatus according to claim 1, wherein
the program information acquisition determining unit outputs the determination based on a program information non-accumulation area obtained by subtracting a program information accumulation area, in which the program information is already accumulated, from a maximum program information accumulation area for accumulating program information in the program information accumulation unit.

3. The program information acquisition apparatus according to claim 2, wherein:
the program information non-accumulation area is obtained for each of the reception targets; and
the program information non-accumulation area for a reception target to which a user does not subscribe is excluded from the determination.

4. The program information acquisition apparatus according to claim 2, wherein:
the program information non-accumulation area is obtained for each of the reception targets; and
the determination is output based on the program information non-accumulation area weighted based on a frequency of channel selection by a user as a reception target.

5. The program information acquisition apparatus according to claim 1, wherein
the program information acquisition unit includes a channel selecting section for selecting a channel as the reception target so as to select all the reception targets in response to an output from the program information acquisition determining unit.

6. The program information acquisition apparatus according to claim 1, wherein:
the program information acquisition unit includes a channel selecting section for selecting a channel as the reception target and a reception target sorting section for sorting out a reception target from which the program information is to be acquired; and
the reception target sorted out by the reception target sorting section is selected in response to an output from the program information acquisition unit.

7. The program information acquisition apparatus according to claim 6, wherein
the reception target sorting section sorts out a reception target from which program information is acquired, based on user setting.

8. The program information acquisition apparatus according to claim 6, wherein
the reception target sorting section sorts out a reception target from which the program information is acquired, based on a frequency of channel selection by a user.

9. A program information acquisition method comprising the steps of:
acquiring program information distributed from a reception target by a program information acquisition unit;
accumulating the acquired program information in a program information accumulation unit; and
determining a start of the acquisition operation by the program information acquisition unit based on an information accumulation status of the program information accumulation unit.

10. A computer-readable medium containing a program information acquisition program which allows a computer to be functioned as:
a program information acquisition unit for acquiring program information distributed from a reception target;
a program information accumulation unit for accumulating the program information acquired by the program information acquisition unit; and
a program information acquisition determining unit for determining a start of the acquisition operation by the program information acquisition unit based on an information accumulation status of the program information accumulation unit.
